(19) United States
(12) Patent Application Publication
(10) Pub. No.: US 2019/0108734 A1
(43) Pub. Date: Apr. 11, 2019

(54) TAMPERING DETECTION SYSTEM FOR FINANCIAL KIOSKS

(71) Applicant: Cook Security Group Inc., Portland, OR (US)

(72) Inventors: Brian COOK, Vancouver, WA (US); Levi DAILY, Medford, OR (US)

(73) Assignee: Cook Security Group Inc., Portland, OR (US)

(21) Appl. No.: 16/132,089

(22) Filed: Sep. 14, 2018

Related U.S. Application Data
(60) Provisional application No. 62/647,570, filed on Mar. 23, 2018.
(60) Provisional application No. 62/569,395, filed on Oct. 6, 2017.

(51) Int. Cl. G08B 13/196; G08B 13/181; H04N 7/18; G07F 19/00

(52) U.S. Cl. CPC G08B 13/19602; G08B 13/181; G07F 19/207; H04N 7/183; G08B 13/19663

(57) ABSTRACT

Methods and systems for safeguarding financial transaction kiosks may include components configured to monitor for criteria indicating tampering with a kiosk. The kiosk may include a safe, a computer disposed external to the safe, and a cash dispensing device disposed at least partially within the safe and selectively coupled to the external computer by an electronic communication path. Using processing logic disposed in the safe, a switch disposed in the electronic communication path may be caused to open in response to detection of one or more of the tampering criteria, thereby automatically severing the communication path.

Crimes such as credit or debit card fraud and the like sometimes involve theft of information at financial kiosks, such as automated teller machines (ATMs) and gas pump payment machines. A common method of surreptitious card information stealing at such kiosks is for a criminal to install a so-called “skimmer.” Skimmers are small electronic devices that obtain card information by reading a card, e.g., the card's magnetic strip. For example, a skimmer may be placed over a kiosk's card slot in such a way that the casual user will not notice when using the kiosk in a normal fashion. Unknown to the user, the skimmer then reads the card information as the user swipes or otherwise passes the card through. In some instances, a camera may also be installed nearby to capture other information, such as entry of a personal identification number (PIN) or the like. Various methods have been attempted over the years to thwart this known problem, including skimmer detection devices on the kiosk. A more reliable, harder to defeat method is needed to detect the installation of skimmers and other nefarious devices on financial kiosks.

### SUMMARY

The tampering detection systems and methods of the present disclosure overcome the problems described above by monitoring the kiosk's data feed, core computer, and/or environment for signs of tampering or abnormal loitering, then (a) shutting down the kiosk and/or (b) alerting a user and providing information to further investigate whether tampering seems to have occurred.

In some embodiments, a financial transaction system may include: a kiosk; a safe housed in the kiosk; a computer disposed external to the safe; a cash dispensing device disposed at least partially within the safe and coupled to the computer by a first electronic communication path; wherein the computer disposed external to the safe is configured to control the dispensing device to selectively dispense cash stored in the safe; a switch disposed in the first electronic communication path and controlled by processing logic disposed in the safe; wherein the processing logic is configured, in response to one or more criteria indicating tampering with the kiosk, to sever the first communication path by causing the switch to open.

In some embodiments, a method for safeguarding financial transaction kiosks may include: monitoring for one or more criteria indicating tampering with a kiosk, wherein the kiosk includes a safe, a computer disposed external to the safe, and a cash dispensing device disposed at least partially within the safe and selectively coupled to the computer by a first electronic communication path, and wherein the computer disposed external to the safe is configured to control the dispensing device to selectively dispense cash stored in the safe; and automatically severing the first communication path, in response to detection of the one or more criteria, by using processing logic disposed in the safe to cause a switch disposed in the first electronic communication path to open.

In some embodiments, a financial transaction system may include: a safe housed in a kiosk; a cash dispensing device disposed at least partially within the safe; a computer disposed external to the safe and coupled to the cash dispensing device by a first electronic communication path, wherein the computer is configured to control the dispensing device to selectively dispense cash stored in the safe; a switch disposed in the first electronic communication path and controlled by processing logic disposed in the safe; and a camera system configured to capture digital images of an area adjacent the kiosk and save the captured digital images; wherein the processing logic is configured, in response to one or more criteria indicating tampering with a kiosk, to automatically sever the first communication path by causing the switch to open and to automatically cause one or more of the captured digital images to be communicated to a remote user.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative loitering detection and alert system in accordance with aspects of the present disclosure.

FIG. 2 is a schematic diagram of an illustrative kiosk suitable for use with aspects of the present disclosure.

FIG. 3 is a flow chart depicting steps of an illustrative loitering detection and alert method in accordance with aspects of the present disclosure.

FIG. 4 is a flow chart depicting steps of an illustrative compliance monitoring method in accordance with aspects of the present disclosure.

FIG. 5 is a schematic diagram of another aspect of the loitering detection and alert system, including another illustrative kiosk.

FIG. 6 is a flow chart depicting steps of an illustrative loitering/tampering detection and kiosk shutdown method in accordance with aspects of the present disclosure

FIG. 7 is a schematic diagram of an illustrative computer suitable for use with systems and methods disclosed herein.

FIG. 8 is a schematic diagram of an illustrative computer network suitable for use with systems and methods described herein.

### DETAILED DESCRIPTION

Various aspects and examples of a tampering detection and alert system for financial kiosks, as well as related methods, are described below and illustrated in the associated drawings. Unless otherwise specified, a tampering detection system and/or its various components may, but are not required to, contain at least one of the structure, components, functionality, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; and (4) Conclusion. The Examples, Components, and Alternatives section is further divided into subsections A through G, each of which is labeled accordingly.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“Coupled” means connected, either permanently or releasably, whether directly or indirectly through intervening components, and is not necessarily limited to physical connection(s).

“Processing logic” may include any suitable device or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

### Overview

In general, a tampering detection and alert system in accordance with the present disclosure (aspects of which are also referred to as a compliance detection system or a loitering detection system) may include a network-based monitoring system configured to receive transaction data (e.g., an electronic journal or log), in real time, from a plurality of financial kiosks (e.g., ATMs). Each kiosk may have one or more associated camera systems that monitor the area surrounding the kiosk and record the imagery (e.g., video) in a local and/or a remote data store, such as using a digital video recorder (DVR). Control software and/or hardware of the camera (e.g., a video analytics module) may be configured to automatically detect loitering, such as a slow moving or stationary person spending an excessive amount of time within a zone around the kiosk, and trigger an alert. The tampering detection system receives the alert and automatically performs an analysis of the kiosk's corresponding transaction log to determine whether a legitimate transaction occurred. If not, a portion of the imagery is automatically retrieved from the camera's stored video feed, and a user is notified to review the imagery and/or the kiosk for signs of tampering.

In some examples, tampering and/or compliance with rules and regulations regarding topics such as sufficient lighting, shrubbery height, and the like may be detected using another aspect of the system. For example, a still image of the scene surrounding the kiosk may be automatically recorded by the camera(s) of each kiosk, at the same time(s) each day. Images taken at the same time on different days (e.g., from successive days or days separated by a selected period) may then be automatically compared to determine whether there has been a change in the scene. In some examples, any change over a certain threshold may automatically trigger an alert to the user.

Accordingly, aspects of the tampering and compliance detection systems described herein may be embodied as a computer method, computer system, or computer program product. Aspects of the tampering and compliance detection systems described herein may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the tampering and compliance detection systems described herein may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or the like. In the context of this disclosure, a computer-readable storage medium may include any suitable non-transitory tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Computer program code for carrying out operations for aspects of the tampering and compliance detection systems described herein may be written in one or any combination of programming languages, including an object-oriented programming language such as Java, Smalltalk, C++, and/or the like, and conventional procedural programming languages, such as C. Mobile apps may be developed using any suitable language, including those previously mentioned, as well as Objective-C, Swift, C#, HTML5, and/or the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the tampering and compliance detection systems of the present disclosure are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s). In some examples, machine-readable instructions may be programmed onto a programmable logic device, such as a field programmable gate array (FPGA).

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block(s).

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the tampering and compliance detection systems of the present disclosure. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of exemplary tampering and/or compliance detection systems, as well as related systems and methods. The examples in these sections are intended for illustration and should not be interpreted as limiting the entire scope of the present disclosure. Each section may include one or more distinct embodiments or examples, and/or contextual or related information, function, and/or structure.

### A. Illustrative Tampering Detection System—Part I

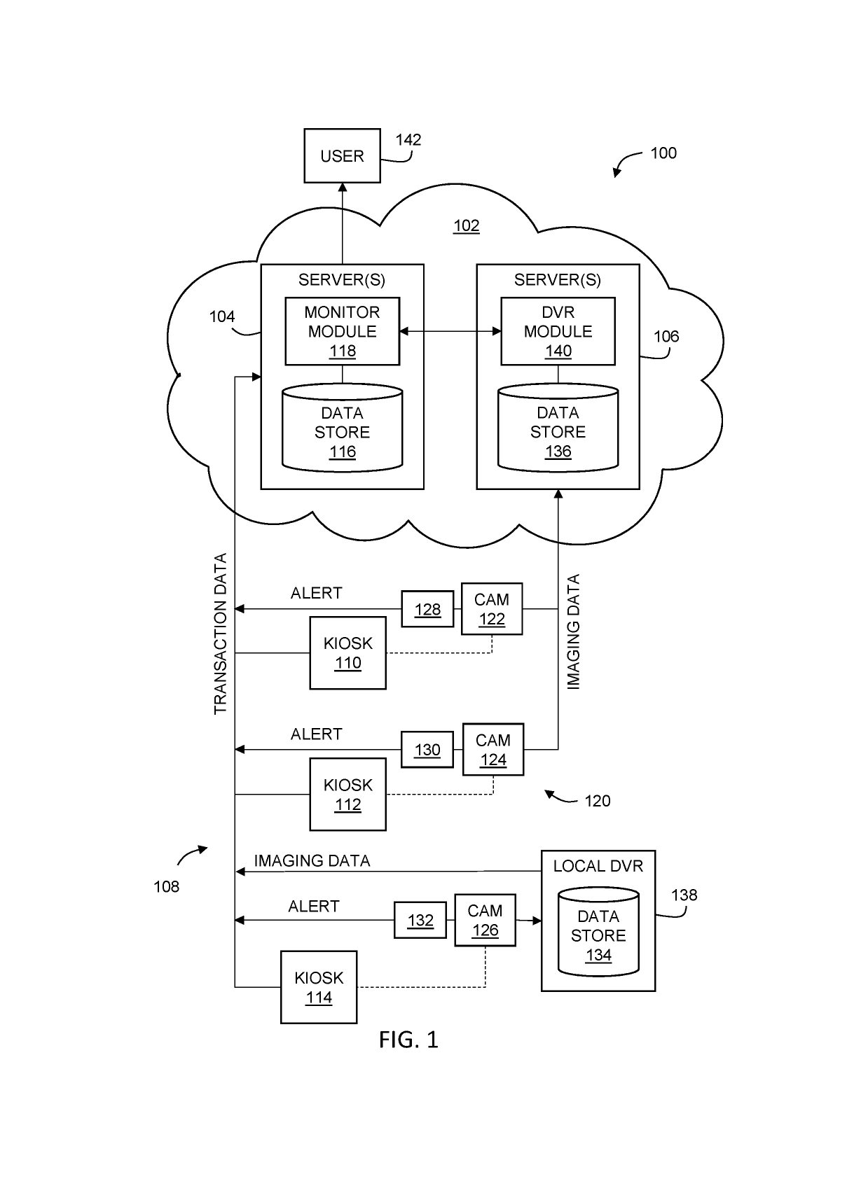

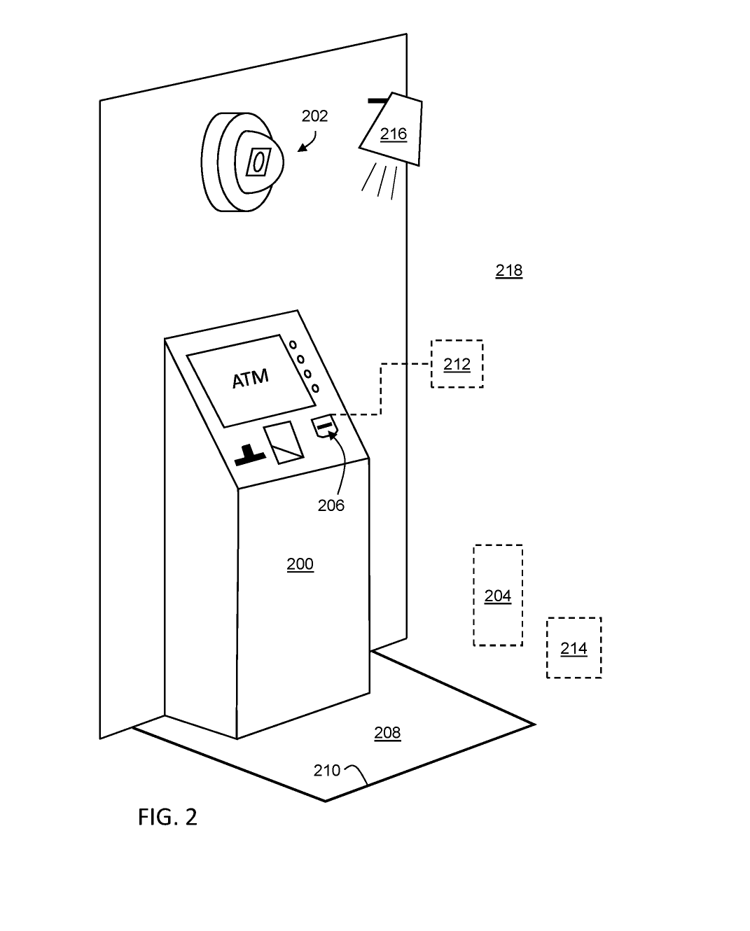

As shown in FIGS. 1-2, this section describes an illustrative tampering detection system 100. System 100 is an example of the tampering or loitering detection system, described above. FIG. 1 is a schematic diagram of system 100, and FIG. 2 is a schematic diagram of an illustrative financial kiosk 200 suitable for use with system 100 and others described in the present disclosure.

System 100 includes a distributed computer network 102, also referred to as a cloud, which includes a plurality of servers, e.g., server(s) 104 and server(s) 106 (see Sections E and F, below). Network 102 is configured to receive data from a plurality of financial kiosks 108, which therefore may be considered part of the computer network. Any number of such kiosks may be present, and in this example three such kiosks are monitored, namely a first financial kiosk 110, a second financial kiosk 112, and a third financial kiosk 114. Each kiosk may include any suitable device configured to conduct automatically one or more financial transactions in response to user interactions with the device. Examples of kiosks include devices such as ATMs and fuel pumps that accept card-based payment methods. An ATM-style kiosk 200 is depicted in FIG. 2, and is an example of kiosks 108.

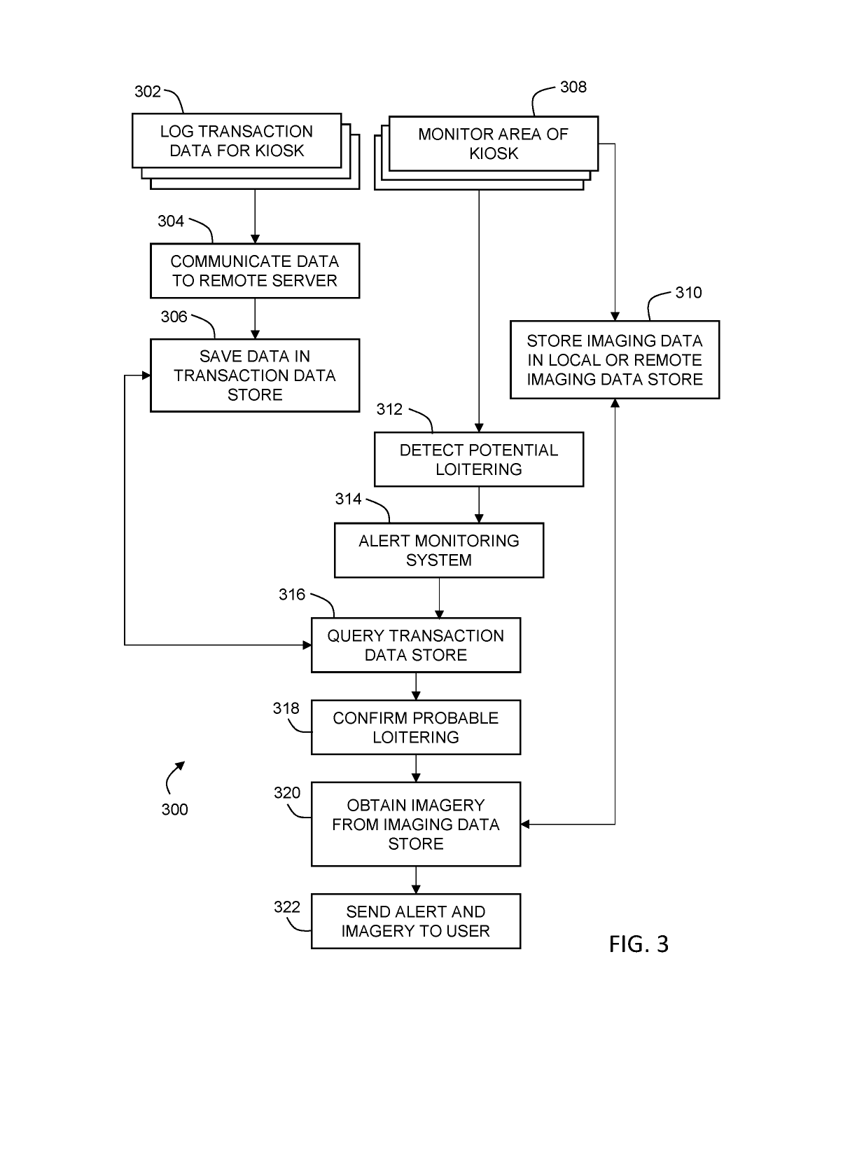

Kiosks 108 each keep track of transactions, including the time and type of each transaction, in a transaction log. For example, ATMs typically record their transactions in what is known as an electronic journal or EJ. In system 100, each kiosk 108 communicates its transactional data (e.g., EJ data) to server(s) 104, in real time or near real time. Server(s) 104 store the transactional data in one or more data stores 116. Server(s) 104 also include a monitoring module 118, which is software configured to carry out a monitoring and/or alerting process, as described with respect to FIG. 3. In some examples, monitoring module 118 and data store(s) 116 are disposed on different physical devices.

Corresponding to the transactional data being saved, one or more cameras 120 or other imaging devices are associated with each kiosk and configured to record images (e.g., video) of the kiosk and a surrounding area. Specifically, representative cameras 120 include a camera 122 associated with kiosk 110, a camera 124 associated with kiosk 112, and a camera 126 associated with kiosk 114. In the example depicted in FIG. 2, a camera 202 is associated with ATM 200. Cameras 120 may include any suitable devices configured to automatically capture images (moving and/or still) of an area surrounding the kiosk, whether in the visible spectrum of light or in another spectrum (e.g., infrared), and to communicate those images digitally to a display and/or a storage device. Examples of suitable cameras 120 include video surveillance products currently offered under the HikVision, FLIR, and Axis brands, among others.

Each camera 120 may have corresponding video analytics software modules, depicted in FIG. 1 at 128, 130, and 132, respectively, which perform video content analysis using known methods to identify spatial and/or temporal events. For example, modules 128, 130, 132 may determine whether a person or object in the image is loitering in a selected region within the field of view. Loitering determination may involve adjustable settings, such as definition of the monitored region, maximum allowable duration spent in the region, and the like. As depicted in FIG. 1, detection of a loitering event that exceeds user threshold(s) may trigger an alert being sent to monitoring module 118.

Cameras 120 may include video imaging devices, and may store video digitally in a local video data store 134 (as in the example of camera 126) and/or remotely in a cloud-based or network-based video data store 136 (as in the examples of cameras 122 and 124). Each video data store may comprise a portion of a digital video recorder (DVR) apparatus comprising the data store and associated software or other controls. For example, a local DVR 138 may be associated with local data store 134 and a remote DVR module 140 may be associated with network data store 136. Other quantities and combinations of data stores, both remote and local, may be utilized with system 100.

In response to receiving a notification or alert from the analytics module of a given camera 120, monitoring module 118 queries data store 116 for transaction data related to the associated kiosk 108. If certain conditions are satisfied, e.g., no transaction was carried out within a selected time period corresponding to the loitering event, then monitoring module 118 may be configured to retrieve imagery from the given camera via its associated DVR. This retrieval may be carried out, e.g., via an application programming interface (API) of the DVR or DVR module. The imagery may take any suitable form, such as a video clip or a series of images, e.g., arranged as a GIF. The retrieved imagery is then communicated to a user, e.g., at a user device 142.

FIG. 3 depicts ATM 200 and associated camera 202. ATM 200 may be configured to dispense cash and conduct other transactions for a user 204 who inserts or swipes a bank card (e.g., credit or debit card) in a card slot 206 of the kiosk. As described above, ATM 200 is monitored by system 100. Accordingly, camera 202 is configured to automatically trigger an alert to the monitoring system if user 204 or any other person or item spends more than a threshold amount of time (e.g., 30 seconds) in a defined region 208 and/or within a defined boundary or border 210. In this example, border 210 is rectangular and region 208 is an area directly in front of ATM 200. In some examples, border 210 and region 208 may have any suitable shape and/or size configured to provide a useful alerting system without an excessive number of false-positives (or false-negatives). As described above, loitering by user 204 without a corresponding valid transaction may be an indication that the individual is acting suspiciously, such as installing a skimmer device 212 or other nefarious activity. Regardless of whether this is specifically nefarious, operators of ATM 200 may wish to discourage loitering at or near their kiosk, for safety, security, and other reasons.

One or more objects 214 may be installed or otherwise present during normal operations of ATM 200. Objects 214 may include items such as one or more pylons, walls, curbs, plants, shrubs, trees, and/or the like, or any combination of these. Another aspect of an environment 216 around ATM 200 is lighting, which is provided and/or supplemented by a lamp 218 installed nearby. In many cases, local and/or federal regulations may govern aspects of environment 218 in the vicinity of a kiosk such as ATM 200. For example, selected minimum lighting regulations may be in place, and selected regulations may govern the placement, height, and/or other characteristics of object(s) 214. For example, shrubbery in environment 218 may have a maximum allowable height. Accordingly, operators of kiosks such as ATM 200 are very interested in being notified of any changes to environment 218.

### B. Illustrative Methods

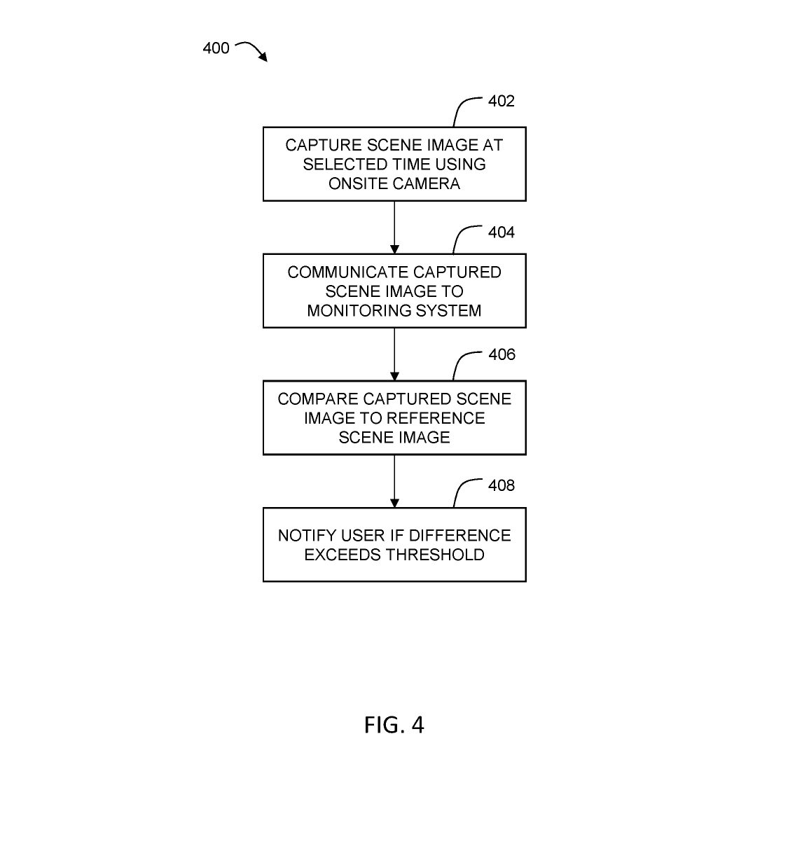

This section describes steps of an illustrative tampering detection method 300 (FIG. 3) and an illustrative compliance monitoring method 400 (FIG. 4). Aspects of system 100 may be utilized in the method steps described below. Where appropriate, reference may be made to components and systems that may be used in carrying out each step. These references are for illustration, and are not intended to limit the possible ways of carrying out any particular step of the method.

FIGS. 3 and 4 are each flowcharts illustrating steps performed in a respective method, and may not recite the complete process or all steps of the method. Although various steps of methods 300 and 400 are described below and depicted in FIGS. 3 and 4, the steps need not necessarily all be performed, and in some cases may be performed simultaneously or in a different order than the order shown.

With reference to FIG. 3, step 302 of method 300 includes logging transaction data for a kiosk (e.g., recording EJ data for kiosks 108, 200). As indicated in FIG. 3, step 302 may be performed for a plurality of kiosks, e.g., simultaneously. Step 304 of method 300 includes communicating the transactional data to a remote server, e.g., as described with respect to server(s) 104. Step 306 of method 300 includes saving the transactional data in a data store of the remote server, e.g., data store 116. Steps 302, 304, and 206 may be performed in real time, or in near real time (e.g., in batches every selected number of seconds or minutes).

Coinciding with steps 302-306, step 308 of method 300 includes monitoring an area or region (e.g., region 208) adjacent to or in the vicinity of the kiosk. For example, monitoring may be performed using a video camera (e.g., cameras 120, 202). Step 310 of method 300 includes storing imaging data from step 308 in a local and/or remote video data store (e.g., data store 134, 136). Steps 310, 306, or other applicable steps may include system-wide synchronization of time stamp information related to the stored data, to ensure imaging and transaction data are able to be accurately matched based on a kiosk identifier and time stamp.

Step 312 of method 300 includes detecting potential loitering in the region of the kiosk, e.g., using a video analytics module associated with the camera. When such potential loitering is detected, step 314 of method 300 includes notifying or communicating the possibility to the monitoring system (e.g., system 100, monitoring module 118). From the camera's perspective, potential loitering will often be indistinguishable from a normal transaction. For example, loitering may be defined as a person being present in the defined region for greater than a selected number of seconds (e.g., 30 seconds). Accordingly, “potential loitering” alerts to the monitoring system can be expected to occur on a fairly regular basis.

Step 316 of method 300 begins the monitoring system's attempt to confirm or disconfirm whether actual loitering may have occurred. Step 316 includes querying the transaction data store (e.g., data store 116) to obtain the transactions that correspond to that kiosk and timeframe. Step 318 of method 300 includes using the retrieved transaction data to confirm whether the potential loitering should be classified as suspicious. For example, system 100 may check whether any valid transaction occurred during the loitering period. In some examples, certain transaction types or sequences may tend to be exculpatory (e.g., valid cash withdrawal or deposit), and other transaction types or sequences (e.g., failed log in) may tend to validate suspicion. Any suitable criteria may be used to confirm probable loitering.

If step 318 results in no confirmation of probable loitering, the system takes no further action. However, if loitering is confirmed as a probability, corresponding imagery is obtained from imaging data storage. For example, monitoring module 118 may query DVR 138 or 140 for a video clip or series of still images that would show the loitering event. Step 322 of method 300 includes sending an alert to a user of the monitoring system (e.g., operator of the kiosk). For example, system 100 may assemble a message identifying the kiosk, the time period, and the video clip (or series of stills) for communicating to a device associated with the user (e.g., user device 142).

In response to receiving the alert, the user may take any suitable action he or she deems appropriate. For example, the user may review the video clip and ascertain that a technician should be dispatched to conduct further physical inspection of the kiosk, to check for tampering, e.g., skimmer installation, or vandalism. In some examples, the video clip may merely reveal non-nefarious loitering, in which case other actions may be warranted. In some examples, the loitering may be innocent or inadvertent, warranting no further action.

Turning to FIG. 4, method 400 addresses another aspect of system 100 suitable for compliance monitoring. Step 402 of method 400 includes automatically capturing a scene image corresponding to a region around a financial kiosk using an onsite camera (e.g., an image of environment 208 by ATM 200 using camera 202) at a selected time of day. To ensure maximum consistency of the images, the selected time may be at night (i.e., no available sunlight) and at a time of low usage (e.g., 2 am or 3 am).

Step 404 of method 400 includes communicating the captured scene image to a monitoring system (e.g., monitoring system 100) and storing the image (e.g., using a dedicated or multi-use data store). The captured scene image may include any suitable image format, such as RAW, GIF, JPEG, PNG, or the like.

Step 406 of method 400 includes automatically comparing the scene image captured in step 402 to a reference image. The reference image may be any suitable image, such as an identically-captured scene image taken on a different day (e.g., the day before). In some examples, the reference image may be from a selected day that does not change (e.g., from a specific date). In some examples, the image from day N may be compared to the image from day N-X, wherein X can have any appropriate value (e.g., 7, 30). In some examples, the reference image may comprise a composite of multiple images, such as a statistical average image generated from a specified number of images. In a preferred embodiment, the scene image is compared to the image of the same scene taken 24 hours earlier.

Comparison may be done using any suitable method. In some examples, comparison may be a pixel by pixel analysis, wherein the comparison results in a measure of the difference between the two images. For example, if a first image shows an object that is not present in a second image, even though the two images are of the same scene, a certain percentage of pixels will be different. Accordingly a straight “percent difference” measurement may be used. In some examples, a weighting scheme may be used, where changes in certain portions of the image are weighted more heavily than in other portions.

Step 408 of method 400 includes automatically notifying a user of the system if the comparison of step 406 results in a difference that exceeds a selected threshold. This selected threshold may be selectable by the user, and may be, for example, 5% or 10% difference. Differences between two images taken on different days may indicate a change in the scene that should be investigated. For example, the camera may have been bumped or blown off target, an object may have appeared, disappeared, or moved. In some examples, the difference may be due to a change in lighting level (e.g., a burned out light bulb). In some examples, comparisons may be done with a recent date (e.g., previous day), with an image from a date farther in the past (e.g., previous month), or both. Comparison over a longer time frame may be beneficial in that slower-moving changes may be identified, such as unacceptable shrubbery growth.

Accordingly, method 400 may be performed by auto-capturing images of the scene adjacent to a kiosk every 24 hours at a time during which the impact of other variables are minimized (e.g., no sunlight, no traffic). Selected ones of the sequence of photos may then be compared to determine whether anything has changed, as measured, e.g., by a pixel-wise difference between images. For example, a photo can be automatically taken each morning at 2 am at a selected kiosk and transmitted to a remote server. The system then automatically notifies the user/operator if the scene appears to have changed by more than a selected, acceptable amount, as compared with the day before (and/or another day). Other frequencies and times of day may be utilized. Notifying the user may include sending one or more images and/or reports. In some examples, the percentage change may be communicated. In some examples, the area that appears to have changed may be highlighted or otherwise identified.

### C. Illustrative Tampering Detection System—Part II

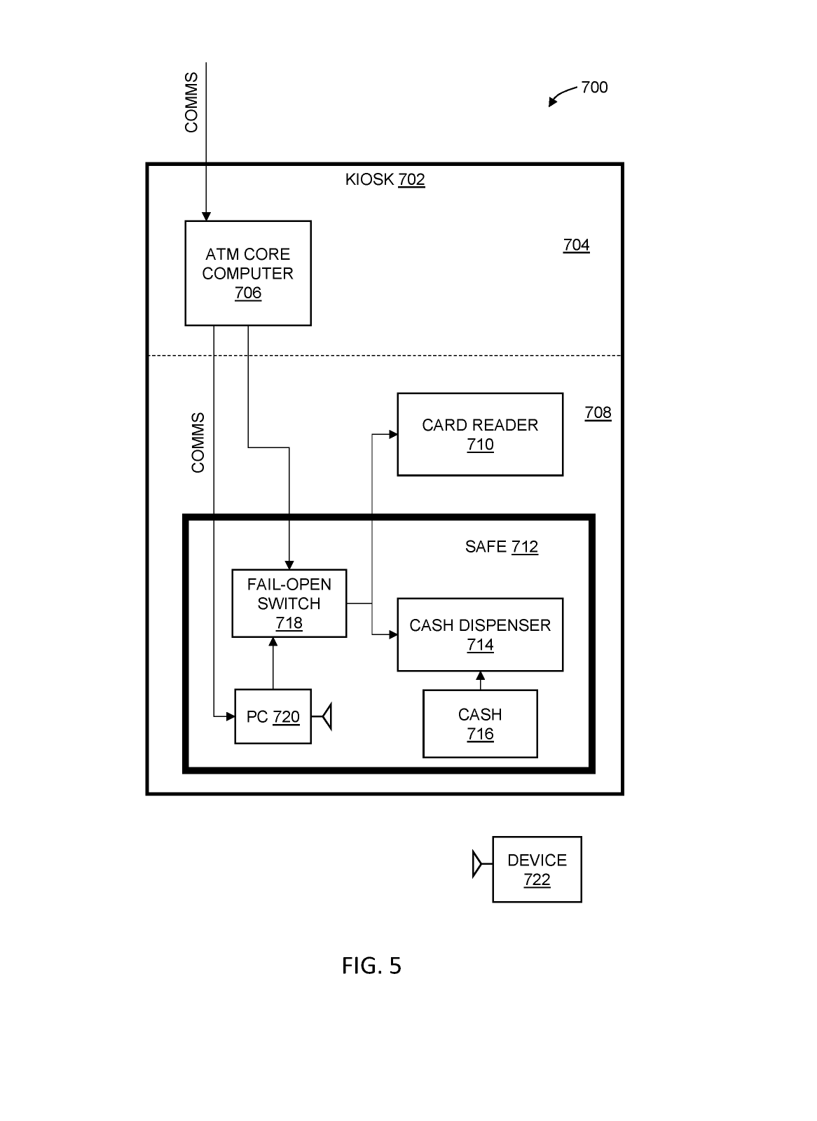

As shown in the schematic diagram of FIG. 5, this section describes an illustrative tampering detection system 700 suitable for integration with system 100, described above. FIG. 5 is a schematic diagram of system 700 embodied in an illustrative financial kiosk 702 (e.g., an ATM) suitable for use with system 100 and others described in the present disclosure.

System 700 is configured to shut down selected components of the kiosk when tampering-related behavior is detected. Aspects of system 700 may be used in place of or in conjunction with aspects of system 100, such as the user alert feature (i.e., an ATM may be shut down and the user alerted). Moreover, system 700 is configured to detect signs of card skimming and/or “jackpotting”—a criminal attack in which the kiosk's controlling computer is physically accessed and hacked in some way. With jackpotting, the hack is utilized to falsely instruct the cash dispenser of the kiosk to dispense money.

In most if not all existing ATMs, the controlling computer is housed in the generally insecure upper portion of the kiosk, while the cash and cash dispenser are in a safe in the more secure lower portion. Accordingly, thieves tend to break into standalone kiosks by physically breaching the upper portion of the device and accessing the core computer located there.

As shown in FIG. 5, financial kiosk 702 includes an upper portion 704, housing a controlling computer 706 (AKA core computer, or core), and a lower portion 708. Lower portion 708 houses multiple components, including a card reader 710 (an example of card reader 206) and a safe 712. Within safe 712, a cash dispenser 714 in communication with a cash supply 716 (e.g., in cartridge(s)), an automatic relay or switch 718, and a system computer 720 are securely enclosed.

System computer 720 is an example of data processing system 500, and comprises processing logic configured to execute one or more algorithms outlined herein, including methods 300, 400, and/or 800 (described below). In this example, computer 720 controls switch 718, and is configured to monitor kiosk core 706 for abnormal indications. In response to selected events (e.g., the core goes offline), system computer 720 is configured to open switch 718, cutting the cash dispenser and/or card reader off from the kiosk's core computer (which may be hacked). Because the system computer and switch 718 are housed inside the safe, they are secure from physical attack and the thief is thwarted. Should power be cut to the kiosk, the system computer, or the switch, the switch will fail open and again no access to the cash dispenser will be possible. Should the system computer lose communications with the network or branch (whichever it is in communication with), again the switch will automatically open.

Additionally or alternatively, system computer 720 may be configured to detect wireless signals (e.g., Bluetooth® signals, WiFi signals, etc.). This functionality, in combination with the processing logic, may be utilized to detect when any unknown (e.g., non-whitelisted) wireless communication devices 722 are within range (e.g., at a selected signal strength) of the kiosk. The presence of such a device for an extended period of time, or without any evidence of a transaction from the EJ, may be used to again indicate suspicious behavior. Based on device settings, the system computer can decide automatically to shut down the kiosk by opening switch 718.

In some examples, the processing logic may be configured to shut down the kiosk (i.e., by disconnecting the dispenser and/or card reader from the core) in response to any event described with respect to system 100 and method 300. For example, if camera-detected loitering is confirmed, system 700 may be utilized to shut down the kiosk, in addition to (or instead of) notifying the user.

### D. Illustrative Method

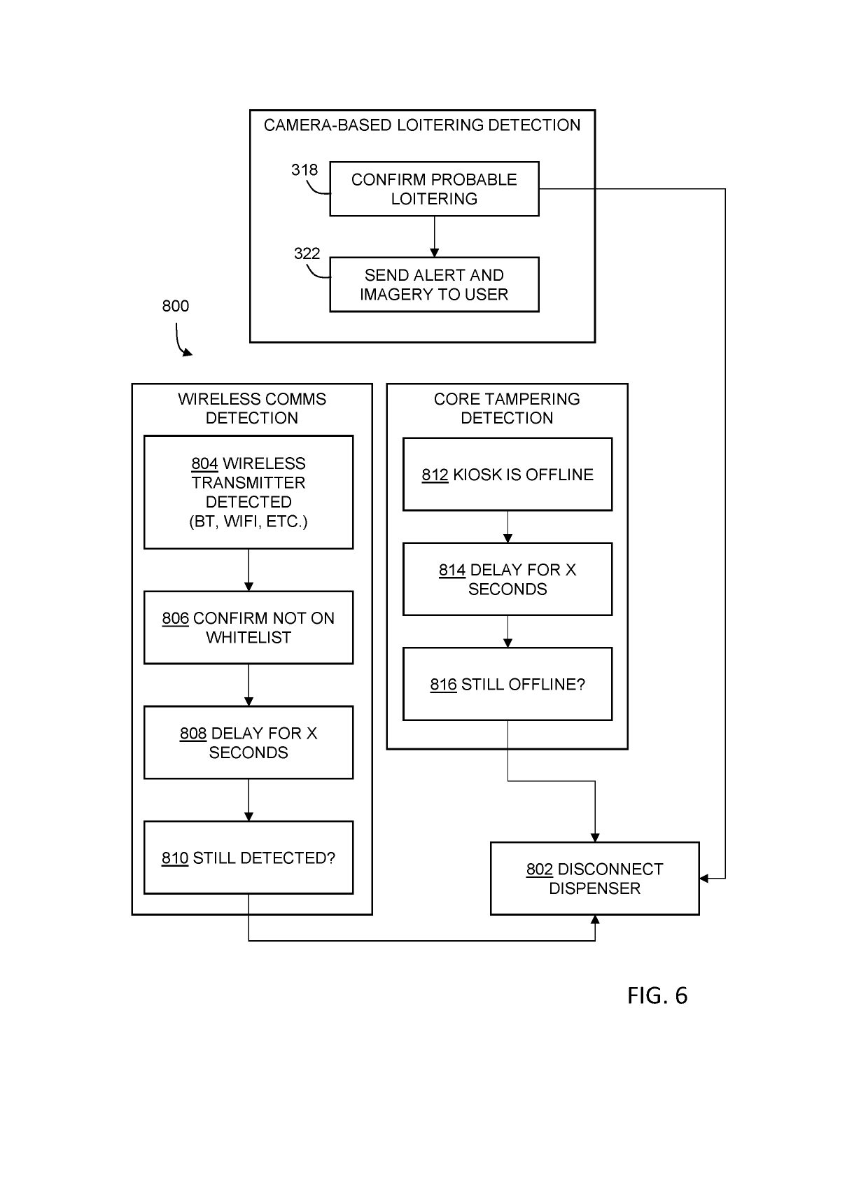

This section describes steps of an illustrative tampering detection method 800; see FIG. 6. Aspects of systems 100 and/or 700 may be utilized in the method steps described below. Where appropriate, reference may be made to components and systems that may be used in carrying out each step. These references are for illustration, and are not intended to limit the possible ways of carrying out any particular step of the method.

FIG. 6 is a flowchart illustrating steps performed in a method, and may not recite the complete process or all steps of the method. Although various steps of method 800 are described below and depicted in FIG. 6, the steps need not necessarily all be performed, and in some cases may be performed simultaneously or in a different order than the order shown.

As depicted in FIG. 6, method 300 ties into the overall process as indicated, such that a determination of probable loitering based on camera detection (see FIG. 3), may trigger a dispenser disconnection from the core at step 802. This disconnection may be carried out in any suitable fashion. For example, system computer 720 may be used to open switch 718, as described above.

In this example, two other modes besides camera detection may also trigger a dispenser disconnection. First, a wireless communications detection mode may be utilized. Specifically, at step 804, a wireless transmitter may be detected by the system (e.g., by computer 720 or any other suitable wireless detector). Wireless may include modalities such as Bluetooth® and WiFi, and any other such technology. As described herein, the wireless detection may be enabled continuously, such that any nearby signal is detected automatically. At step 806, the system checks the detected signal against a white list of known devices that are assumed to be trustworthy. This white list may be developed as part of system set-up, and updated as needed when configurations change over time. At step 808, a selected delay may be carried out, for example, to prevent false alarms from normal kiosk users (e.g., carrying a smart phone). At step 810, if the unknown signal emitter is still detected, the kiosk may be automatically shut down at step 802.

Second, a core tampering detection mode may be utilized. At step 812, the system recognizes that the kiosk is offline. This may be determined in any suitable manner, such as by monitoring for communications from the core, detecting power-down, etc. When the kiosk is offline, a selected delay may be instituted at step 814 to prevent any false alarms. At step 816, if the kiosk is still determined to be offline, then the dispenser is automatically disconnected at step 802.

All three modes may be enabled, individually or in any combination, as desired. Although dispenser disconnection is specifically mentioned, any combination of kiosk features may be disabled by controlling each of them with the same or a co-controlled switch. For example, as shown in FIG. 5, the card reader and the cash dispenser can bot be simultaneously cut off from the core computer.

### E. Illustrative Data Processing System

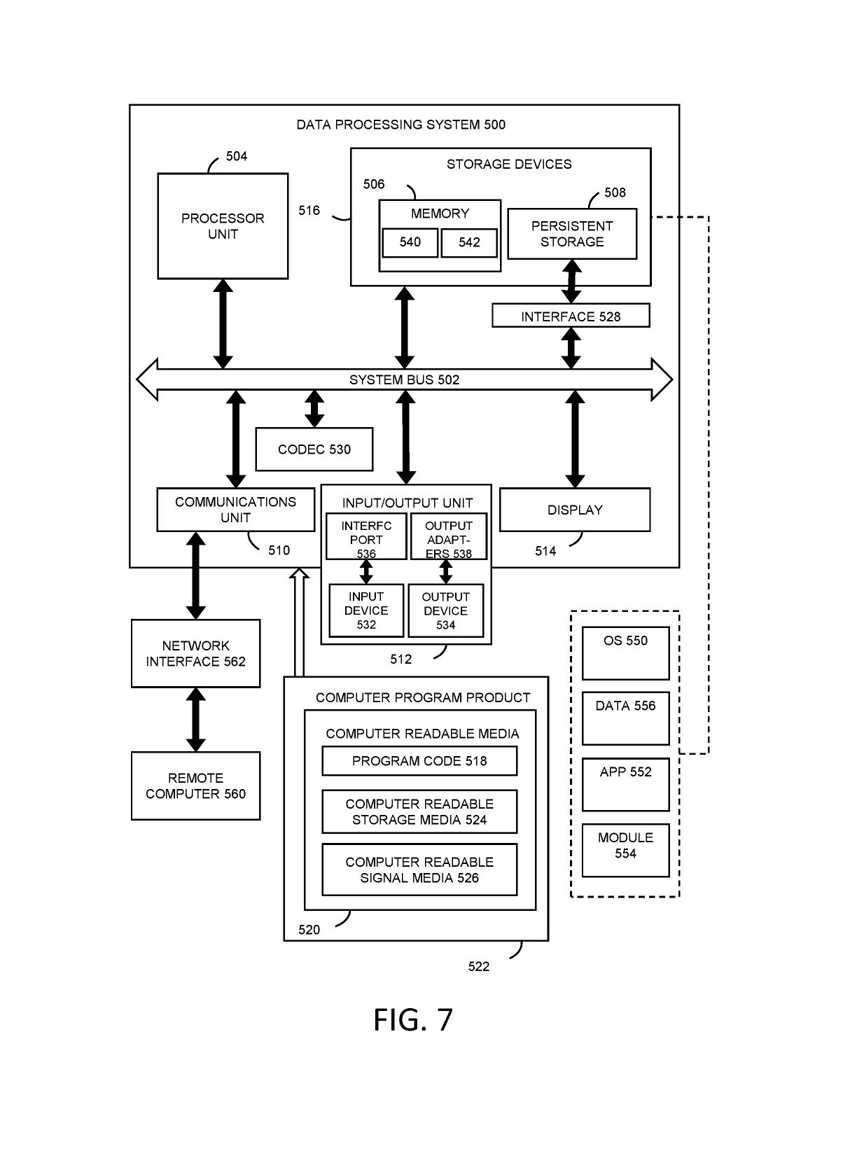

As shown in FIG. 7, this example describes a data processing system 500 (also referred to as a computer, computing system, and/or computer system) in accordance with aspects of the present disclosure. In this example, data processing system 500 is an illustrative data processing system suitable for implementing aspects of the tampering and compliance detection systems described herein. More specifically, in some examples, devices that are embodiments of data processing systems (e.g., smartphones, servers, personal computers) may be used to embody server(s) 104 and 106, DVR 138, user device 142, as well as portions of camera systems 120 (e.g., to run analytics modules). Operational algorithms of kiosks 108 may also be carried out by one or more computers.

In this illustrative example, data processing system 500 includes a system bus 502 (also referred to as communications framework). System bus 502 may provide communications between a processor unit 504 (also referred to as a processor or processors), a memory 506, a persistent storage 508, a communications unit 510, an input/output (I/O) unit 512, a codec 530, and/or a display 514. Memory 506, persistent storage 508, communications unit 510, input/output (I/O) unit 512, display 514, and codec 530 are examples of resources that may be accessible by processor unit 504 via system bus 502.

Processor unit 504 serves to run instructions that may be loaded into memory 506. Processor unit 504 may comprise a number of processors, a multi-processor core, and/or a particular type of processor or processors (e.g., a central processing unit (CPU), graphics processing unit (GPU), etc.), depending on the particular implementation. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device may include any suitable hardware capable of storing information (e.g., digital information), such as data, program code in functional form, and/or other suitable information, either on a temporary basis or a permanent basis.

Storage devices 516 also may be referred to as computer-readable storage devices or computer-readable media. Memory 506 may include a volatile storage memory 540 and a non-volatile memory 542. In some examples, a basic input/output system (BIOS), containing the basic routines to transfer information between elements within the data processing system 500, such as during start-up, may be stored in non-volatile memory 542. Persistent storage 508 may take various forms, depending on the particular implementation.

Persistent storage 508 may contain one or more components or devices. For example, persistent storage 508 may include one or more devices such as a magnetic disk drive (also referred to as a hard disk drive or HDD), solid state disk (SSD), floppy disk drive, tape drive, Jaz drive, Zip drive, LS-50 drive, flash memory card, memory stick, and/or the like, or any combination of these. One or more of these devices may be removable and/or portable, e.g., a removable hard drive. Persistent storage 508 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 508 to system bus 502, a removable or non-removable interface is typically used, such as interface 528.

Input/output (I/O) unit 512 allows for input and output of data with other devices that may be connected to data processing system 500 (i.e., input devices and output devices). For example, input device 532 may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 504 through system bus 502 via interface port(s) 536. Interface port(s) 536 may include, for example, a serial port, a parallel port, a game port, and/or a universal serial bus (USB).

Output devices 534 may use some of the same types of ports, and in some cases the same actual ports, as input device(s) 532. For example, a USB port may be used to provide input to data processing system 500 and to output information from data processing system 500 to an output device 534. Output adapter 538 is provided to illustrate that there are some output devices 534 (e.g., monitors, speakers, and printers, among others) which require special adapters. Output adapters 538 may include, e.g. video and sounds cards that provide a means of connection between the output device 534 and system bus 502. Other devices and/or systems of devices may provide both input and output capabilities, such as remote computer(s) 560. Display 514 may include any suitable human-machine interface or other mechanism configured to display information to a user, e.g., a CRT, LED, or LCD monitor or screen, etc.

Communications unit 510 refers to any suitable hardware and/or software employed to provide for communications with other data processing systems or devices. While communication unit 510 is shown inside data processing system 500, it may in some examples be at least partially external to data processing system 500. Communications unit 510 may include internal and external technologies, e.g., modems (including regular telephone grade modems, cable modems, and DSL modems), ISDN adapters, and/or wired and wireless Ethernet cards, hubs, routers, etc. Data processing system 500 may operate in a networked environment, using logical connections to one or more remote computers 560. A remote computer(s) 560 may include a personal computer (PC), a server, a router, a network PC, a workstation, a microprocessor-based appliance, a peer device, a smart phone, a tablet, another network note, and/or the like. Remote computer(s) 560 typically include many of the elements described relative to data processing system 500. Remote computer(s) 560 may be logically connected to data processing system 500 through a network interface 562 which is connected to data processing system 500 via communications unit 510. Network interface 562 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 530 may include an encoder, a decoder, or both, comprising hardware, software, or a combination of hardware and software. Codec 530 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 530 is depicted as a separate component, codec 530 may be contained or implemented in memory, e.g., non-volatile memory 542.

Non-volatile memory 542 may include read only memory (ROM), programmable ROM (PROM), electrically programmable ROM (EPROM), electrically erasable programmable ROM (EEPROM), flash memory, and/or the like, or any combination of these. Volatile memory 540 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 516, which are in communication with processor unit 504 through system bus 502. In these illustrative examples, the instructions are in a functional form in persistent storage 508. These instructions may be loaded into memory 506 for execution by processor unit 504. Processes of one or more embodiments of the present disclosure may be performed by processor unit 504 using computer-implemented instructions, which may be located in a memory, such as memory 506.

These instructions are referred to as program instructions, program code, computer usable program code, or computer-readable program code executed by a processor in processor unit 504. The program code in the different embodiments may be embodied on different physical or computer-readable storage media, such as memory 506 or persistent storage 508. Program code 518 may be located in a functional form on computer-readable media 520 that is selectively removable and may be loaded onto or transferred to data processing system 500 for execution by processor unit 504. Program code 518 and computer-readable media 520 form computer program product 522 in these examples. In one example, computer-readable media 520 may comprise computer-readable storage media 524 or computer-readable signal media 526.

Computer-readable storage media 524 may include, for example, an optical or magnetic disk that is inserted or placed into a drive or other device that is part of persistent storage 508 for transfer onto a storage device, such as a hard drive, that is part of persistent storage 508. Computer-readable storage media 524 also may take the form of a persistent storage, such as a hard drive, a thumb drive, or a flash memory, that is connected to data processing system 500. In some instances, computer-readable storage media 524 may not be removable from data processing system 500.

In these examples, computer-readable storage media 524 is a non-transitory, physical or tangible storage device used to store program code 518 rather than a medium that propagates or transmits program code 518. Computer-readable storage media 524 is also referred to as a computer-readable tangible storage device or a computer-readable physical storage device. In other words, computer-readable storage media 524 is media that can be touched by a person.

Alternatively, program code 518 may be transferred to data processing system 500, e.g., remotely over a network, using computer-readable signal media 526. Computer-readable signal media 526 may be, for example, a propagated data signal containing program code 518. For example, computer-readable signal media 526 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 518 may be downloaded over a network to persistent storage 508 from another device or data processing system through computer-readable signal media 526 for use within data processing system 500. For instance, program code stored in a computer-readable storage medium in a server data processing system may be downloaded over a network from the server to data processing system 500. The computer providing program code 518 may be a server computer, a client computer, or some other device capable of storing and transmitting program code 518.

In some examples, program code 18 may comprise be an operating system (OS) 550. Operating system 550, which may be stored on persistent storage 508, controls and allocates resources of data processing system 500. One or more applications 552 take advantage of the operating system's management of resources via program modules 554, and program data 556 stored on storage devices 516. OS 550 may include any suitable software system configured to manage and expose hardware resources of computer 500 for sharing and use by applications 552. In some examples, OS 550 provides application programming interfaces (APIs) that facilitate connection of different type of hardware and/or provide applications 552 access to hardware and OS services. In some examples, certain applications 552 may provide further services for use by other applications 552, e.g., as is the case with so-called “middleware.” Aspects of present disclosure may be implemented with respect to various operating systems or combinations of operating systems.

The different components illustrated for data processing system 500 are not meant to provide architectural limitations to the manner in which different embodiments may be implemented. One or more embodiments of the present disclosure may be implemented in a data processing system that includes fewer components or includes components in addition to and/or in place of those illustrated for computer 500. Other components shown in FIG. 7 can be varied from the examples depicted. Different embodiments may be implemented using any hardware device or system capable of running program code. As one example, data processing system 500 may include organic components integrated with inorganic components and/or may be comprised entirely of organic components (excluding a human being). For example, a storage device may be comprised of an organic semiconductor.

In some examples, processor unit 504 may take the form of a hardware unit having hardware circuits that are specifically manufactured or configured for a particular use, or to produce a particular outcome or progress. This type of hardware may perform operations without needing program code 518 to be loaded into a memory from a storage device to be configured to perform the operations. For example, processor unit 504 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 518) may be implemented as hardware, e.g., by specifying an FPGA configuration using a hardware description language (HDL) and then using a resulting binary file to (re)configure the FPGA.

In another example, data processing system 800 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 504 may be implemented using a combination of processors found in computers and hardware units. Processor unit 504 may have a number of hardware units and a number of processors that are configured to run program code 518. With this depicted example, some of the processes may be implemented in the number of hardware units, while other processes may be implemented in the number of processors.

In another example, system bus 502 may comprise one or more buses, such as a system bus or an input/output bus. Of course, the bus system may be implemented using any suitable type of architecture that provides for a transfer of data between different components or devices attached to the bus system. System bus 502 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 510 may include a number of devices that transmit data, receive data, or both transmit and receive data. Communications unit 510 may be, for example, a modem or a network adapter, two network adapters, or some combination thereof. Further, a memory may be, for example, memory 506, or a cache, such as that found in an interface and memory controller hub that may be present in system bus 502.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

### F. Illustrative Distributed Data Processing System

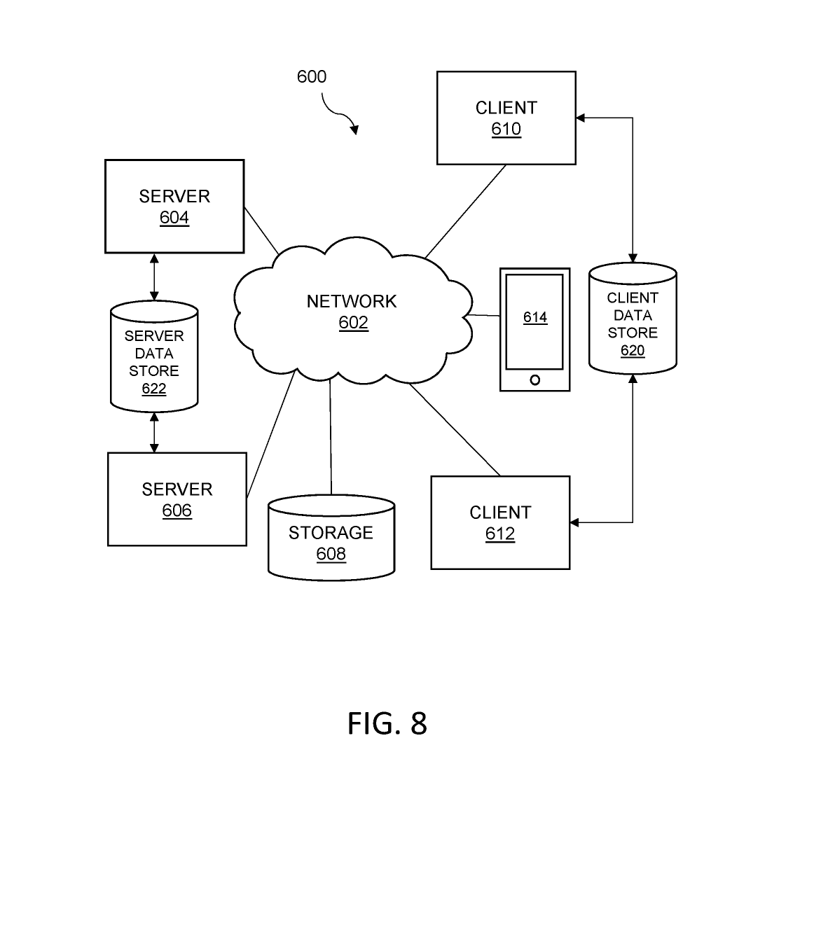

As shown in FIG. 8, this example describes a general network data processing system 600, interchangeably termed a computer network, a network system, a distributed data processing system, or a distributed network, aspects of which may be included in one or more illustrative embodiments of the tampering and compliance monitoring systems described herein. For example, as shown in FIG. 1, network 102 may include a distributed data processing system that connects a plurality of servers (e.g., servers 104 and 106) with each other and with a plurality of financial kiosks and camera systems (e.g., kiosks 108 and cameras 120).

It should be appreciated that FIG. 8 is provided as an illustration of one implementation and is not intended to imply any limitation with regard to environments in which different embodiments may be implemented. Many modifications to the depicted environment may be made.

Network system 600 is a network of devices (e.g., computers), each of which may be an example of data processing system 500, and other components. Network data processing system 600 may include network 602, which is a medium configured to provide communications links between various devices and computers connected within network data processing system 600. Network 602 may include connections such as wired or wireless communication links, fiber optic cables, and/or any other suitable medium for transmitting and/or communicating data between network devices, or any combination thereof.

In the depicted example, a first network device 604 and a second network device 606 connect to network 602, as do one or more computer-readable memories or storage devices 608. Network devices 604 and 606 are each examples of data processing system 500, described above. In the depicted example, devices 604 and 606 are shown as server computers, which are in communication with one or more server data store(s) 622 that may be employed to store information local to server computers 604 and 606, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 610 and 612 and/or a client smart device 614, may connect to network 602. Each of these devices is an example of data processing system 500, described above regarding FIG. 7. Client electronic devices 610, 612, and 614 may include, for example, one or more personal computers, network computers, and/or mobile computing devices such as personal digital assistants (PDAs), smart phones, handheld gaming devices, wearable devices, and/or tablet computers, and the like. In the depicted example, server 604 provides information, such as boot files, operating system images, and applications to one or more of client electronic devices 610, 612, and 614. Client electronic devices 610, 612, and 614 may be referred to as “clients” in the context of their relationship to a server such as server computer 604. Client devices may be in communication with one or more client data store(s) 620, which may be employed to store information local to the clients (e.g., cookie(s) and/or associated contextual information). Network data processing system 600 may include more or fewer servers and/or clients (or no servers or clients), as well as other devices not shown.

In some examples, first client electric device 610 may transfer an encoded file to server 604. Server 604 can store the file, decode the file, and/or transmit the file to second client electric device 612. In some examples, first client electric device 610 may transfer an uncompressed file to server 604 and server 604 may compress the file. In some examples, server 604 may encode text, audio, and/or video information, and transmit the information via network 602 to one or more clients.

Client smart device 614 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 600 may be stored in or on a computer-readable storage medium, such as network-connected storage device 608 and/or a persistent storage 508 of one of the network computers, as described above, and may be downloaded to a data processing system or other device for use. For example, program code may be stored on a computer-readable storage medium on server computer 604 and downloaded to client 610 over network 602, for use on client 610. In some examples, client data store 620 and server data store 622 reside on one or more storage devices 608 and/or 508.

Network data processing system 600 may be implemented as one or more of different types of networks. For example, system 600 may include an intranet, a local area network (LAN), a wide area network (WAN), or a personal area network (PAN). In some examples, network data processing system 600 includes the Internet, with network 602 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 602 may be referred to as a “cloud.” In those examples, each server 604 may be referred to as a cloud computing node, and client electronic devices may be referred to as cloud consumers, or the like. FIG. 8 is intended as an example, and not as an architectural limitation for any illustrative embodiments.

### G. Illustrative Combinations and Additional Examples

This section describes additional aspects and features of tampering detection and alert systems for financial kiosks, as well as related methods, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A financial transaction system comprising: a kiosk; a safe housed in the kiosk; a computer disposed external to the safe; a cash dispensing device disposed at least partially within the safe and coupled to the computer by a first electronic communication path; wherein the computer disposed external to the safe is configured to control the dispensing device to selectively dispense cash stored in the safe; a switch disposed in the first electronic communication path and controlled by processing logic disposed in the safe; wherein the processing logic is configured, in response to one or more criteria indicating tampering with the kiosk, to sever the first communication path by causing the switch to open.

A1. The system according to A0, wherein the switch is configured to fail open upon loss of power.

A2. The system according to any one of paragraphs A0 through A1, further comprising a second electronic communication path from the computer to the processing logic, wherein the one or more criteria include a loss of communication between the computer and the processing logic.

A3. The system according to any one of paragraphs A0 through A2, further comprising a third electronic communication path between the computer and an electronic card reader of the kiosk, wherein the switch is disposed in the third electronic communication path, such that the third electronic communication path is severed whenever the first electronic communication path is severed.

A4. The system according to any one of paragraphs A0 through A3, further comprising an antenna coupled to the processing logic; wherein the one or more criteria include detection, by the processing logic using the antenna, of an unknown wireless transmitter having a signal strength greater than a selected threshold for longer than a selected duration.

A5. The system according to any one of paragraphs A0 through A4, further comprising: a camera system configured to capture digital images of an area adjacent the kiosk and record the captured digital images, wherein the camera system is configured to communicate a loitering-detected signal in response to loitering detected in the captured digital images; a system controller configured, in response to receiving the loitering-detected signal from the camera system, to corroborate the loitering by automatically retrieving and analyzing transaction data for the kiosk during a time associated with the captured images, such that a corroboration by the transaction data results in a confirmed detection of loitering.

A6. The system of A5, wherein processing logic of the kiosk comprises the system controller.

A7. The system of A5, wherein the system controller is further configured, in response to receiving the loitering-detected signal from the camera system, to communicate an alert and the captured digital images to a remote user.

A8. The system of A5, wherein the one or more criteria include the confirmed detection of loitering.

B0. A method for safeguarding financial transaction kiosks, the method comprising: monitoring for one or more criteria indicating tampering with a kiosk, wherein the kiosk includes a safe, a computer disposed external to the safe, and a cash dispensing device disposed at least partially within the safe and selectively coupled to the computer by a first electronic communication path, and wherein the computer disposed external to the safe is configured to control the dispensing device to selectively dispense cash stored in the safe; and automatically severing the first communication path, in response to detection of the one or more criteria, by using processing logic disposed in the safe to cause a switch disposed in the first electronic communication path to open.

B1. The method according to B0, the kiosk further comprising a second electronic communication path from the computer to the processing logic, wherein the one or more criteria include a loss of communication between the computer and the processing logic.

B2. The method according to any one of paragraphs B0 through B1, the kiosk further comprising an antenna coupled to the processing logic; wherein the one or more criteria include detection, by the processing logic using the antenna, of an unknown wireless transmitter having a signal strength greater than a selected threshold for longer than a selected duration.

B3. The method according to any one of paragraphs B0 through B2, further comprising: automatically severing a third electronic communication path between the computer and an electronic card reader of the kiosk whenever the first electronic communication path is severed.

B4. The method according to any one of paragraphs B0 through B3, further comprising: capturing digital images of an area adjacent the kiosk using a camera system; saving the captured digital images; in response to loitering automatically detected in the captured digital images, using the camera system to communicate a loitering-detected signal to a system controller; and in response to receiving the loitering-detected signal from the camera system, corroborating the loitering using the system controller by automatically retrieving and analyzing transaction data for the kiosk during a time associated with the captured images, such that a corroboration by the transaction data results in a confirmed detection of loitering.

B5. The method of B4, wherein the processing logic of the kiosk comprises the system controller.

B6. The method of B4, wherein the system controller is further configured, in response to receiving the loitering-detected signal from the camera system, to communicate an alert and the captured digital images to a remote user.

B7. The method of B4, wherein the one or more criteria include the confirmed detection of loitering.

C0. A financial transaction system comprising: a safe housed in a kiosk; a cash dispensing device disposed at least partially within the safe; a computer disposed external to the safe and coupled to the cash dispensing device by a first electronic communication path, wherein the computer is configured to control the dispensing device to selectively dispense cash stored in the safe; a switch disposed in the first electronic communication path and controlled by processing logic disposed in the safe; and a camera system configured to capture digital images of an area adjacent the kiosk and save the captured digital images; wherein the processing logic is configured, in response to one or more criteria indicating tampering with a kiosk, to automatically sever the first communication path by causing the switch to open and to automatically cause one or more of the captured digital images to be communicated to a remote user.

C1. The system of C0, wherein the one or more criteria include a confirmed detection of loitering, the confirmed detection of loitering comprising an automatic detection of loitering by the camera system in the captured digital images, automatically corroborated by the processing logic by analysis of transaction data for the kiosk during a time associated with the captured images.

C2. The system of C0 or C1, further comprising a second electronic communication path from the computer to the processing logic, wherein the one or more criteria include a loss of communication between the computer and the processing logic.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A financial transaction system comprising:
a kiosk;
a safe housed in the kiosk;
a computer disposed external to the safe;
a cash dispensing device disposed at least partially within the safe and coupled to the computer by a first electronic communication path;
wherein the computer disposed external to the safe is configured to control the dispensing device to selectively dispense cash stored in the safe;
a switch disposed in the first electronic communication path and controlled by processing logic disposed in the safe;
wherein the processing logic is configured, in response to one or more criteria indicating tampering with the kiosk, to sever the first communication path by causing the switch to open.

2. The system of claim 1, wherein the switch is configured to fail open upon loss of power.

3. The system of claim 1, further comprising a second electronic communication path from the computer to the processing logic, wherein the one or more criteria include a loss of communication between the computer and the processing logic.

4. The system of claim 1, further comprising a third electronic communication path between the computer and an electronic card reader of the kiosk,
wherein the switch is disposed in the third electronic communication path, such that the third electronic communication path is severed whenever the first electronic communication path is severed.

5. The system of claim 1, further comprising an antenna coupled to the processing logic;
wherein the one or more criteria include detection, by the processing logic using the antenna, of an unknown wireless transmitter having a signal strength greater than a selected threshold for longer than a selected duration.

6. The system of claim 1, further comprising:
a camera system configured to capture digital images of an area adjacent the kiosk and record the captured digital images, wherein the camera system is configured to communicate a loitering-detected signal in response to loitering detected in the captured digital images;
a system controller configured, in response to receiving the loitering-detected signal from the camera system, to corroborate the loitering by automatically retrieving and analyzing transaction data for the kiosk during a time associated with the captured images, such that a corroboration by the transaction data results in a confirmed detection of loitering.

7. The system of claim 6, wherein processing logic of the kiosk comprises the system controller.

8. The system of claim 6, wherein the system controller is further configured, in response to receiving the loitering-detected signal from the camera system, to communicate an alert and the captured digital images to a remote user.

9. The system of claim 6, wherein the one or more criteria include the confirmed detection of loitering.

10. A method for safeguarding financial transaction kiosks, the method comprising:
monitoring for one or more criteria indicating tampering with a kiosk, wherein the kiosk includes a safe, a computer disposed external to the safe, and a cash dispensing device disposed at least partially within the safe and selectively coupled to the computer by a first electronic communication path, and wherein the computer disposed external to the safe is configured to control the dispensing device to selectively dispense cash stored in the safe; and
automatically severing the first communication path, in response to detection of the one or more criteria, by using processing logic disposed in the safe to cause a switch disposed in the first electronic communication path to open.

11. The method of claim 10, the kiosk further comprising a second electronic communication path from the computer to the processing logic, wherein the one or more criteria include a loss of communication between the computer and the processing logic.

12. The method of claim 10, the kiosk further comprising an antenna coupled to the processing logic;
wherein the one or more criteria include detection, by the processing logic using the antenna, of an unknown wireless transmitter having a signal strength greater than a selected threshold for longer than a selected duration.

13. The method of claim 10, further comprising:
automatically severing a third electronic communication path between the computer and an electronic card reader of the kiosk whenever the first electronic communication path is severed.

14. The method of claim 10, further comprising:
capturing digital images of an area adjacent the kiosk using a camera system;
saving the captured digital images;
in response to loitering automatically detected in the captured digital images, using the camera system to communicate a loitering-detected signal to a system controller; and
in response to receiving the loitering-detected signal from the camera system, corroborating the loitering using the system controller by automatically retrieving and analyzing transaction data for the kiosk during a time associated with the captured images, such that a corroboration by the transaction data results in a confirmed detection of loitering.

15. The method of claim 14, wherein the processing logic of the kiosk comprises the system controller.

16. The method of claim 14, wherein the system controller is further configured, in response to receiving the loitering-detected signal from the camera system, to communicate an alert and the captured digital images to a remote user.

17. The method of claim 14, wherein the one or more criteria include the confirmed detection of loitering.

18. A financial transaction system comprising:
a safe housed in a kiosk;
a cash dispensing device disposed at least partially within the safe;
a computer disposed external to the safe and coupled to the cash dispensing device by a first electronic communication path, wherein the computer is configured to control the dispensing device to selectively dispense cash stored in the safe;
a switch disposed in the first electronic communication path and controlled by processing logic disposed in the safe; and
a camera system configured to capture digital images of an area adjacent the kiosk and save the captured digital images;
wherein the processing logic is configured, in response to one or more criteria indicating tampering with a kiosk, to automatically sever the first communication path by causing the switch to open and to automatically cause one or more of the captured digital images to be communicated to a remote user.

19. The system of claim 18, wherein the one or more criteria include a confirmed detection of loitering, the confirmed detection of loitering comprising an automatic detection of loitering by the camera system in the captured digital images, automatically corroborated by the processing logic by analysis of transaction data for the kiosk during a time associated with the captured images.

20. The system of claim 18, further comprising a second electronic communication path from the computer to the processing logic, wherein the one or more criteria include a loss of communication between the computer and the processing logic.
